(19) United States
(12) Patent Application Publication
(10) Pub. No.: US 2010/0326875 A1
(43) Pub. Date: Dec. 30, 2010

(54) Method for making a reception assembly and an reception assembly

(76) Inventor: Joseph S. Wycech, St. Clair Shores, MI (US)

Correspondence Address: John G. Chupa;Law Offices of John Cupa and Associates, P.C., Suite 50, 28535 Orchard Lake Rd., Farmington Hills, MI, 48334, US

(21) Appl. No.: 12/800,935

(22) Filed: May 26, 2010

Related U.S. Application Data
(63) Continuation-in-part of application No. 11/600,473, filed on Nov. 16, 2006, now Pat. No. 7,820,002.

(51) Int. Cl. B65D 81/02; B29C 67/00; B32B 37/16

(52) U.S. Cl. 206/521; 264/239; 156/242

(57) ABSTRACT

A methodology 10 which produces a reception assembly 101 which is biodegradable and which is adapted to selectively receive and support an item, such as a vehicular hood.

This Application is a Continuation-In-Part of currently pending U.S. patent application Ser. No. 11/600,473 which was filed on Nov. 16, 2006, and to which priority is Claimed.

### GENERAL BACKGROUND

1. Field of the Invention

The present invention generally relates to a method for making a reception assembly and to a reception assembly and, more particularly, to a method for making or forming, in one non-limiting embodiment, a three dimensional pocket reception assembly which is adapted to be bio-degradable, easily formed, and structurally sound and to such a three dimensional pocket assembly which is formed by this process.

2. Background of the Invention

Items, such a vehicular hood, are typically transported in styrofoam type or based containers in order to reduce the likelihood of damage to the items during transportation and to provide a secure reception/transportation structure.

While such styrofoam containers (e.g., reception assemblies) do structurally support and protect such items, they have become relatively costly and are environmentally undesirable since they do not quickly degrade once discarded (e.g., they remain within a landfill for a very long time). Moreover, these styrofoam type or based containers emit carcinogenic and other types of harmful fumes when burned, thereby representing a safety hazard and are typically formed by a method which requires the use of hazardous materials.

There is therefore a need for a new and improved container/reception assembly which overcomes some or all of the disadvantages of prior containers and reception assemblies and for a new and improved method for creating and forming such a new and improved container and reception assembly.

### SUMMARY OF THE INVENTION

It is first non-limiting object of the invention to provide a reception assembly which overcomes some or all of the previously delineated drawbacks associated with current reception assemblies.

It is a second non-limiting object of the present invention to provide a method for forming a reception assembly which overcome some or all of the previously delineated drawbacks associated with current reception assembly forming methods.

It is a third non-limiting object of the present invention to provide a method for forming a reception assembly which utilizes only readily biodegradable materials and which produces a reception assembly which is readily biodegradable but which supports and protects items such as vehicular hoods.

According to a first non-limiting aspect of the present invention, a method for making a reception assembly is provided and includes the steps of creating a first portion; creating a second portion; spraying at least a portion of the first portion with a certain material; placing the first and second portions on a surface while abutting the first portion to the second portion; obtaining a male tool; heating the male tool while pressing the male tool onto the first and the second portions, thereby forming a pocket within the previously sprayed portion of the first portion; releasing the first and second portions from the tool; folding the first portion with respect to the second portion, thereby forming the reception assembly.

According to a second non-limiting aspect of the present invention, a method for forming a reception assembly is provided and includes the steps of creating a first portion; creating a second portion; placing reinforcement material upon the first portion; placing a certain second material upon the first portion; placing the first and second portions on a surface while abutting the first portion to the second portion; obtaining a male tool; heating the male tool while pressing the male tool onto the first and the second portions, thereby forming a pocket within the portion of the first portion which received the second material; releasing the first and second portions from the tool; folding the first portion with respect to the second portion, thereby forming the reception assembly According to a third non-limiting aspect of the present invention, a reception assembly is provided and includes a first portion which is formed from a biodegradable cellulosic material; a second portion which is formed from a biodegradable cellulosic material and which is joined to the first portion by a heat forming seam and which includes a heat formed pocket.

According to a fourth non-limiting aspect of the present invention, a method for forming a reception assembly is provided and includes the steps of obtaining biodegradable material; cutting said biodegradable material; and only after cutting said biodegradable material, forming a pocket within said cut biodegradable material.

According to a fifth non-limiting aspect of the present invention, a method for forming a reception assembly is provided and includes the steps of obtaining biodegradable material; cutting said biodegradable material to form at least a perimeter of a pocket; and compressing the portion of said biodegradable material which resides within said perimeter, thereby forming a pocket.

According to a sixth non-limiting aspect of the present invention, a method for forming a reception assembly is provided and includes the steps of obtaining a first biodegradable portion; obtaining a second biodegradable portion having a flat surface; cutting said first biodegradable portion; forming a pocket within said first biodegradable portion only after said first biodegradable portion is cut; coupling said second biodegradable portion to said first biodegradable portion such that said flat surface of said second biodegradable portion overlays said formed pocket, thereby, forming a reception assembly.

According to a seventh non-limiting aspect of he present invention, a method of forming a reception assembly is provided and includes the steps of forming a first layer of biodegradable material; forming a second layer of biodegradable material; obtaining a reinforced material; placing said reinforced material between first and second layers of biodegradable material; and coupling said reinforced material to the first and second layers of the biodegradable material, thereby, forming a reception assembly.

According to an eighth non-limiting aspect of the present invention, a method for forming a reception assembly is provided and includes the steps of obtaining a first portion of biodegradable material; obtaining a second portion of biodegradable material;

determining the shape of an item to be received by the reception assembly; shaping the first portion of the biodegradable material to the shape of a first portion of the determined shape; shaping the second portion of the biodegradable material to the shape of a second portion of the determined shape; and causing said shaped first biodegradable portion to be positioned with respect to the second biodegradable portion, effective to cause the first and second biodegradable portions to cooperatively form a reception assembly.

According to a ninth non-limiting aspect of the present invention, a reception assembly is provided and includes a plurality of separate layers of biodegradable material which are each separated and coupled to a layer of reinforcement material.

According to a tenth non-limiting aspect of the present invention, a reception assembly is provided and includes a first biodegradable portion having a pocket; and a second biodegradable portion which is coupled to the first biodegradable portion and which has a flat surface which overlaps the pocket.

These and other features, aspects, and advantages of the present invention will become apparent from a reading of the following detailed description of the preferred embodiment of the invention and by reference to the following drawings.

### BRIEF DESCRIPTION OF THE DRAWINGS

FIG. 1 is a flow chart which includes the various steps of the preferred reception assembly formation method of the present inventions.

FIG. 2 is a perspective view of a reception assembly which is made in accordance with the teachings of one non-limiting embodiment of the inventions.

FIG. 3 is a partial perspective view of a tool which is made according to the teachings of the preferred embodiment of the invention in combination with two biodegradable members.

FIG. 4 is a view of the tool which is shown in FIG. 3 in the direction of view arrow 4.

FIG. 5 is an exploded view of the cellulosic material which is shown in FIG. 3.

FIG. 6 is a perspective view of several reception assemblies being used to cooperatively transport/protect an item.

FIG. 7 is a perspective view of a tool which is made and utilized in accordance with the teaching of an alternate and non-limiting embodiment of the various inventions.

FIG. 8 is a perspective view of a tool which is made in accordance with the teachings of another alternate and non-limiting embodiment of the various inventions.

FIG. 9 is a side view of a tool which is made in accordance with the teaching of yet another alternate and non-limiting embodiment of the various inventions.

FIG. 10 is a perspective view of a reception assembly which is made in accordance with the teaching of another alternate and non-limiting embodiment of the various inventions.

FIG. 11 is a perspective view if a reception assembly which is made in accordance with the teachings of yet another alternate and non-limiting embodiment of the inventions.

FIG. 12 is a perspective view of a reception assembly which is made in accordance with the teachings of a further alternate and non-limiting embodiment of the inventions.

FIG. 13 is a perspective view of a reception assembly which is made in accordance with the teachings of another non-limiting embodiment of the various inventions.

FIG. 14 is a perspective view of a reception assembly which is made in accordance with the teachings of yet another non-limiting embodiment of the various inventions.

FIG. 15 is a perspective view of a reception assembly which is made in accordance with the teachings of yet another non-limiting embodiment of the various inventions.

FIG. 16 is a side view of a reception assembly which is made in accordance with the teaching of yet another non-limiting embodiment of the various inventions.

FIG. 17 is a side view of a tool made in accordance with the teachings of these inventions cutting and forming a pocket within a blank.

FIG. 18 is a side view of a tool made in accordance with a second of the teachings of these inventions cutting and forming a pocket within a blank.

FIG. 19 is a top perspective view of a blank which is made in accordance with the teachings of an alternate embodiment of the invention.

FIG. 20 is a partial side view of the blank which is shown in FIG. 19.

FIG. 21 is a partial cross sectional view of a reception assembly which is made in accordance with the teachings of an alternate embodiment of the invention.

FIG. 22 is a view of the reception assembly which is shown in FIG. 21 in the direction of view arrow “22”.

FIG. 23 is a partial cross sectional view of a reception assembly which is made in accordance with the teachings of another alternate embodiment of the invention.

FIG. 24 is a view of the reception assembly which is shown in FIG. 23 in the direction of view arrow “24”.

FIG. 25 is a partial cross sectional view of a reception assembly which is made in accordance with the teachings of yet another alternate embodiment of the invention.

FIG. 26 is a view of the reception assembly which is shown in FIG. 25 in the direction of view arrow “26”.

FIG. 27 is a partial cross sectional view of a reception assembly which is made in accordance with the teachings of another alternate embodiment of the invention.

FIG. 28 is a view of the reception assembly which is shown in FIG. 25 in the direction of view arrow “28”.

FIG. 29 is a flow chart illustrating the various steps which cooperatively comprise a reception assembly forming methodology of an alternate embodiment of the invention.

FIG. 30 is a partial side view of the combination of a tool and reception assembly which is formed by the tool.

FIG. 31 is a partial side view of the combination of another tool and a reception assembly which is formed by this tool.

FIG. 32 is a partial side view of the combination of yet another tool and a reception assembly which is formed by this tool.

FIG. 33 is a partial side view of the combination of a different tool and a reception assembly which is formed by this tool.

FIG. 34 is a partial side view of the combination of yet a different tool and a reception assembly which is formed by this tool.

FIG. 35 is a perspective view of a reception assembly which may be formed in accordance with the teachings of the various embodiments of the inventions.

FIG. 36 is a perspective view of another reception assembly which may be formed in accordance with the teachings of the various embodiments of the inventions.

FIG. 37 is a block diagram of a testing methodology conducted on various embodiments of the invention.

FIG. 38 is a side perspective views of one of the various reception assemblies tested according to the methodology of the invention.

FIGS. 39(A-E) are each graphical representation of the results of the testing over an those reception assemblies shown in FIG. 37.

### DETAILED DESCRIPTION OF THE PREFERRED EMBODIMENT OF THE INVENTION

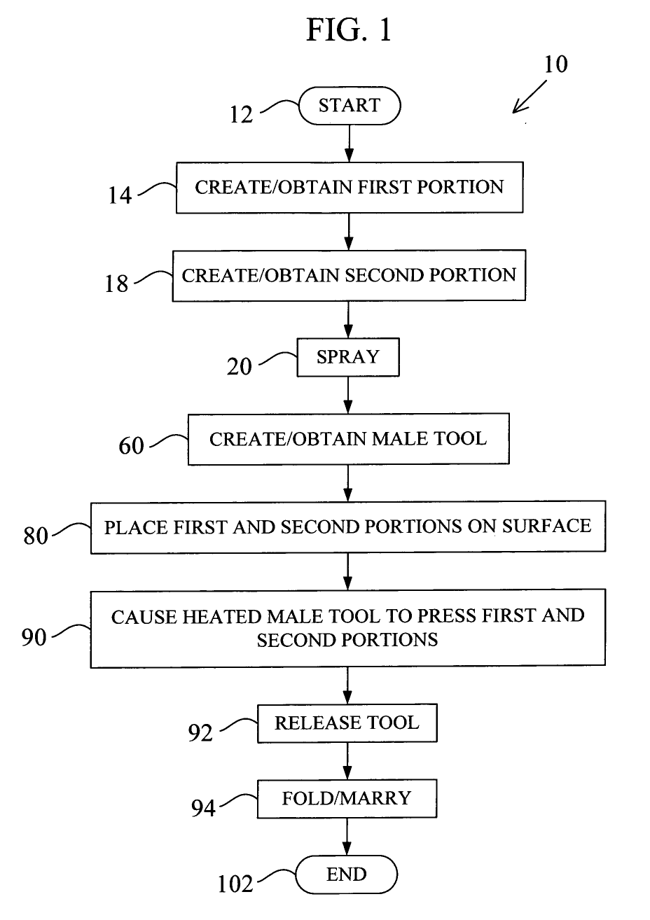

Referring now to FIG. 1, there is shown a flowchart 10 which comprises a sequence of steps which cooperatively form the methodology of the preferred embodiment of the invention.

Particularly, the methodology 10 begins with an initial step 12 in which it is determined that a new reception/container member or assembly needs to be selectively formed. It should be appreciated that, in this description, the terms “reception” and “container” each refer to a member or assembly which is adapted to receive and support an item, such as by way of example and without limitation, a vehicular hood. Hence, these two terms may be used interchangeably and therefore the terms “container assembly” and “reception assembly” mean the same thing for purposes of this description. That is, the terms “a reception assembly” and “a container assembly” each mean one or more members which are used to receive, protect, and transport an item, such as a vehicular hood.

Step 12 is followed by step 14 in which a first portion or member is obtained or created. By way of example and without limitation, this first portion or member is bio-degradable (e.g., readily “breaks down” or degrades when placed out of doors in a natural environment) and may comprise corn based cellulosic material or “greencell”. Other types of cellulose based or bio-degradable material may be used to make the first portion.

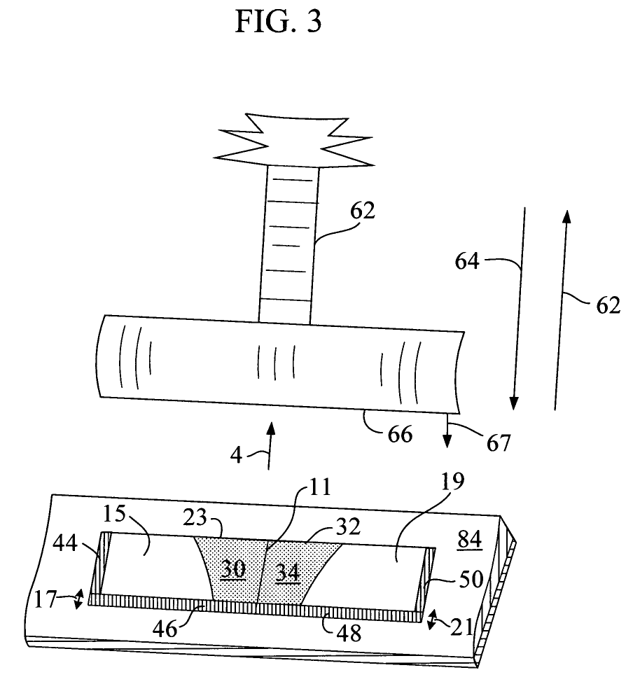

It should be appreciated that the shape, size and overall geometric characteristics of this first portion or member may vary and that nothing in this description is meant to limit this first portion or member to any particular shape, size or geometric orientation. For example, as is perhaps shown best in FIG. 3, a first portion 15 may have a generally rectangular shape and may have a certain desired thickness 17.

Step 14 is followed by step 18 in which a second member or portion is obtained or created. In one non-limiting embodiment of the invention, the second portion is substantially similar in shape, size, overall geometric orientation and material constituency to the first portion. However, in other non-limiting embodiments of the invention, this second portion may have a different shape, size, and overall geometric orientation to that of the first portion and the second portion may be created from a different biodegradable material than the first portion.

By way of example and without limitation, as shown best in FIG. 3, this second portion 19 may also have a generally rectangular shape and size and may also have a certain desired thickness 21.

Step 20 is followed by step 18 and, in this step 20, in one non-limiting embodiment of the invention, a surface area of first portion 15 within which a pocket is to be formed, such as surface area 23, selectively receives a certain material 30. Similarly, a surface area 32 of the second portion 19 within which a pocket is to be formed, such as surface area 32, selectively receives a certain second material 34. Further, the surface areas of the first portion 15 which are to selectively mate with surface areas of the second portion 19, such as surface areas 44, 46 also receive this first material 30. Similarly, the surface areas of the second portion 19 which are to selectively mate with the surface areas of the first portion 15, such as surface areas 48, 50, also receive this second material 34. In one non-limiting embodiment of the invention, the first material 30 is substantially similar to the second material 34 and each material comprises either water or a combination of white glue and water. Other types of material may be utilized. It should be appreciated that first and second materials 30, 34 may not be needed in all embodiments.

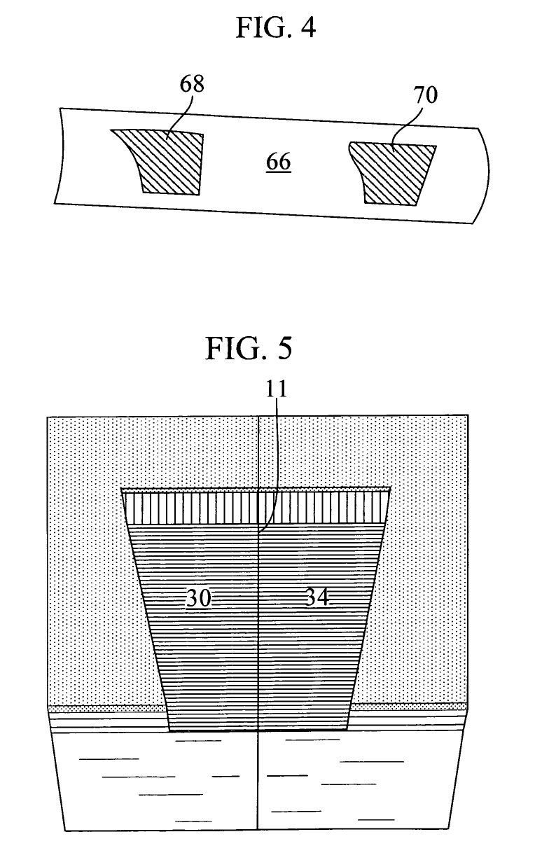

Step 60 follows step 20 and, in this step 60, a male tool such as male tool 62 is created and/or obtained. Particularly, the tool 60 is adapted to be selectively and reciprocally movable along the directions 62, 64 (e.g., by means of a hydraulic or some other sort of actuation assembly (not sown)) and includes a bottom “portion contacting surface” 66 (see, for example, FIG. 4) which includes, in one non-limiting embodiment of the invention, male protrusions 68, 70 which each protrude away from surface 66 in he direction 67.

In this non-limiting embodiment, male protrusion 68 is substantially similar in size and shape to surface area 23 while male protrusion 70 is similar in size and shape to surface area 32. Particularly, it should be realized that each “treated surfaces” (e.g., the respective pocket forming surfaces 23, 32 of the first and second portions 15, 19 which respectively receive material 30, 34) has a unique male protrusion portion, such as portions 68, 70, associated with it and that the uniquely associated male protrusion portion must be the same size and shape as the surface portion to which it is uniquely associated.

Step 60 is followed by step 80 in which the first and second portions 15, 19 are placed upon a general flat platen or surface 84 which is positioned below the selectively and reciprocally moving tool 62. In one non-limiting embodiment, portions 15, 19 abut along edge 11. Particularly, pocket forming and treated surfaces, such as treated surfaces 23, 32 are made to communicate with the bottom surface 66 of the tool 62 (i.e., made to be selectively and respectively engaged by unique portions of the bottom surface 66).

Step 90 follows step 80 and, in this step 90, the surface 66 is heated and then the tool 62 is moved in direction 64 such that the heated surface 66 is made to engage the first and second portions 15, 19 such that male protrusion portion 68 is aligned with and engages and penetrates the treated surface portion 30 and such that the male protrusion portion 70 is aligned with and engages and penetrates the treated surface portion 34. Particularly, the previously deposited materials 30, 34 and the heat, aid the tool 62 in creating these pockets. In this manner, portion 68 forms a pocket within surface portion 30 and portion 70 forms a pocket within surface portion 34 (see, for example, FIG. 5). In the event that more pockets are to be formed in a portion, such as portion 15, each male protrusion member is aligned with the treated surface to which it is uniquely associated and then each male protrusion member is made to respectively engage their respective and uniquely associated treated surfaces, thereby allowing the various male protrusion portions to cooperatively form pockets in each such treated surface of the portion.

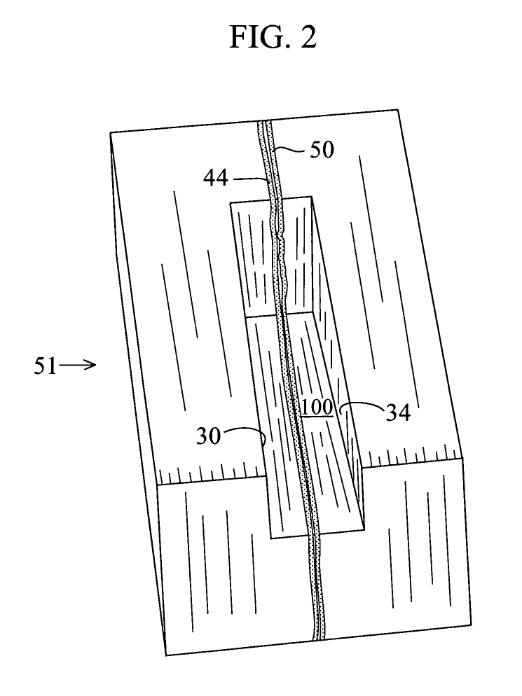

Step 92 follows step 90 and, in this step 92, the tool 62 is moved in the direction 62 away from the platen 84 and step 94 follows step 92 and, in this step 94, the first and second portions 15, 19 are folded and “married” in the manner shown in FIG. 2. That is, surface 44 is made to engage surface 50, surface 46 is made to engage surface 48 and the formed pockets in surface areas 30, 34 are made to communicate and to cooperatively form a reception area 100. Particularly, the combination of the previously deployed materials 30, 34 and the heat from the tool 62 allows the married surfaces 46, 48 to “stick” or “join together” and further allows the married surfaces 44, 50 to similarly “stick” or “join together”. Additional glue/other material maybe added between the engaged surfaces 44, 50 and 46, 48 to further secure the coupling of portion 15 to portion 19. Step 102 follows step 94 in which the created reception assembly 101 may be trimmed or “sized” appropriately or simply utilized as constructed.

In an alternate embodiment of the invention, reinforcing material in the form of tissue paper, cloth, and/or corrugated dust may be applied on the portions 15, 19 before the heated tool 62 engages the portions 15, 19 in order to structurally strengthen the reception assembly 101. The pressure and the heat from the tool 62 cause the deposited reinforcing material to adhere to the surfaces of portions 15, 19.

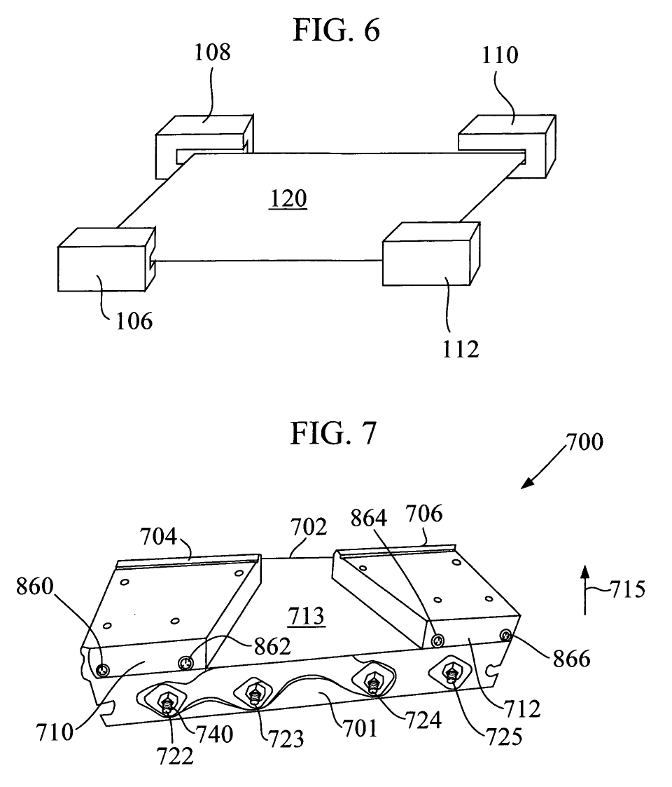

As shown best in FIG. 6, reception members 106, 108, 110, 112 may cooperatively receive and secure a vehicle or hood 120, or other item, for transportation and then be easily and “cleanly” disposed of after use and that such members 106-112 cooperatively form a “reception assembly” In other scenarios, only one such member may be needed to protect/secure/transport and item and this one such member may solely represent an “assembly”. Various non-limiting reception embodiments and tools for making such embodiments will now be discussed. In a broad non-limiting strategy, as is more fully delineated below, a blank having one or more layers of biodegradable material and one or more layers of reinforcing material which structurally strengthens the blank. It is this blank which is used to create the final reception assembly but the use of one of several tools which are each adapted to form the blank in a desired shape.

Referring now to FIGS. 7, 8, 17 there is shown a tool 700 which is made in accordance with the teachings of an alternate and non-limiting embodiment of the various inventions, and which may be used in another non-limiting methodology of the present inventions.

Particularly, the tool 700 includes a generally rectangular body 701 having a back edge 702 upon which a pair of substantially identical and generally rectangular blades 704, 706 are attached and protrude. Further, the tool 700 includes a pair of pocket formers 710 712 which are operatively deployed upon (or are integrally formed with) and protrude from the body 701. The pair of substantially identical pocket formers 710, 712 protrude away from the top surface 713 of the tool 700 in a direction 715, and blades 704, 706 similarly protrude away from the surface 713 in a direction 715. However, in one non-limiting embodiment, the blades 704, 706 are dissimilar in size and shape, as are the pocket formers 710, 712.

Further, in one non-limiting embodiment, the blades 704, 706 protrude away from the top surface 713 more than the formers 710, 712. Additionally, a plurality of heating elements or wires 722, 723, 724, and 725 may be optionally and operatively embedded within the body 701 (it should be realized that the term “elements”, as used in this description, includes wires or substantially anything else to which energy may be communicated and which, upon receipt of such energy, generates heat). In one non-limiting embodiment, each of the elements 722, 723, 724, and 725 respectively terminate into a substantially identical receptacle 740 which are each respectively, and selectively coupled to bus 727 and bus 727 may be selectively and removably coupled to a source of electrical energy and such energy, by use of bus 727, is respectively provided and communicated to the embedded wires 722, 723, 724, ad 725. The generated heat from the elements 722, 723, 724, and 725 is effective to selectively heat the blades 704, 706 and the pocket formers 710, 712.

In another non-limiting embodiment, heating element pairs 860, 862 are embedded in former 710 while element pairs 864, 866 are embedded in former 712 and these pairs 860, 860; and 864,866 are coupled to a bus which connects them to a source of electrical energy and are respectively effective, upon the respective receipt of electrical energy, to heat the formers 710, 712.

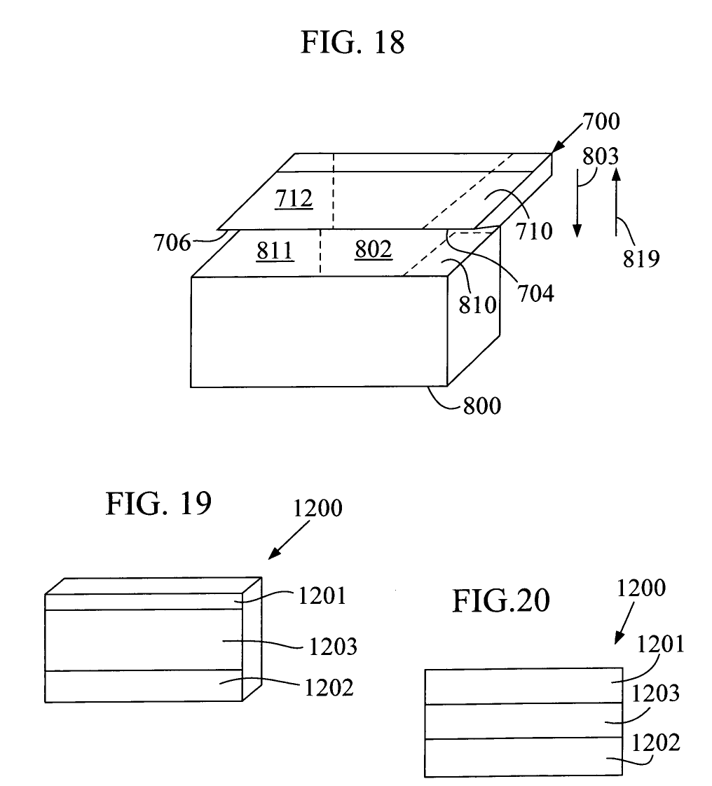

In operation, as is perhaps shown best in FIG. 18, a bio-degradable blank 800, having in one non-limiting embodiment of the various inventions, the shape of a block, is obtained. The material which is formed into the “blank” shape may correspond to commercially available “greencell” material, or to substantially any other type of bio-degradable material. The tool 700 is positioned above the flat top surface 802 of the blank 800 and the tool 700 is then moved downward (in the direction 803) against the surface 802. In this manner, the blank 800 is initially cut by the protruding blades 704, 706 and such a cut is made to properly size the created pocketed item.

In one non-limiting embodiment, blade 706 may extend around the periphery or perimeter of pocket former 712 and blade 704 may extend around the periphery or perimeter of pocket former 710.

After the cutting operation has begun, the pocket formers 710, 712 penetrate the surface 802 and cooperatively form a pair of pockets 810, 811 in the surface 802. Each pocket 810, 811 respectively correspond to and are substantially similar to the former 710, 712 which it was respectively formed by. After the cutting operation and the pocket formation operation is finished, the tool 700 is selectively retracted away (in direction 819) from the blank 800 which is now cut to size and which has a pair of pockets 81, 811 formed within it. The heat which may be communicated to the elements 722, 723, 724, and 725 (and, in an alternate configuration, elements 860, 862, 864,866), cause the blades 704, 706 and the formers 710, 712 to become heated and such heat allows the blades 704, 706 to more easily cut the blank 800 and such heat further allows the pocket formers 704, 706 to more easily penetrate the surface 802 to respectively form the pockets 810, 811.

It should be realized that various types of tools, such as by way of example and without limitation tool 700, may be create and utilized depending upon the size, shape, and number of pockets to be placed or formed within the blank. It should be realized that, in this non-limiting embodiment, the blank 800 is cut before the pockets 810, 811 are begun to be formed and such initial cutting has been formed to allow the pockets 810, 811 to be formed easier and much more precisely.

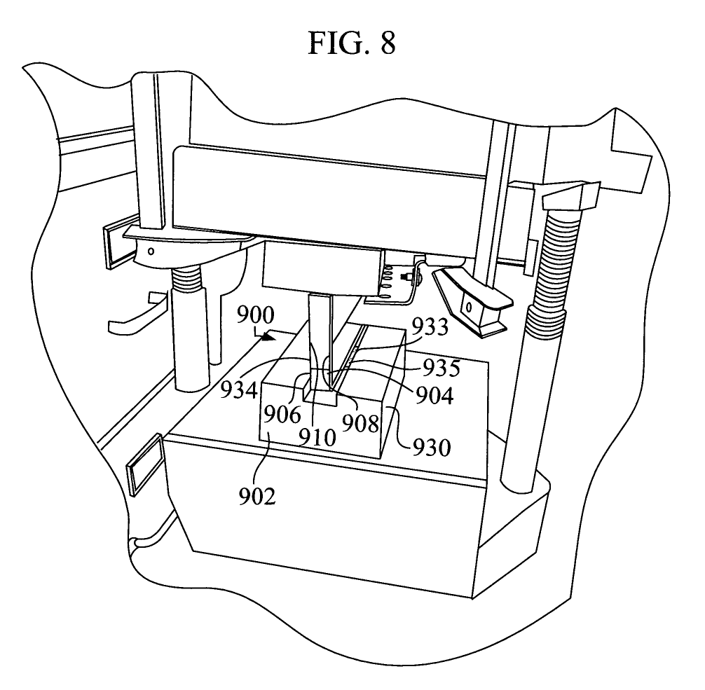

For example, as best shown in FIG. 8, tool 900 may be created having a generally rectangular body 902 and having blades 904, 906 which are respectively attached to (or are integrally formed with) body sides 908, 910. The blades 904, 906 respectively protrude away from the body 902.

In operation, as best shown in FIG. 8, the blades 904, 906 (which may be selectively heated in the foregoing manner) are made to initially penetrate the blank of bio-degradable material 930 and the blades 904, 906 respectively form the opposed perimeter edges 933, 9347 of the pocket 935, which is then formed in the blank 930 as the body 902 is forced into the blank 930. When the pocket 935 is formed, the tool 900 is retracted away from the blank 930 which now has the pocket 935 formed within it.

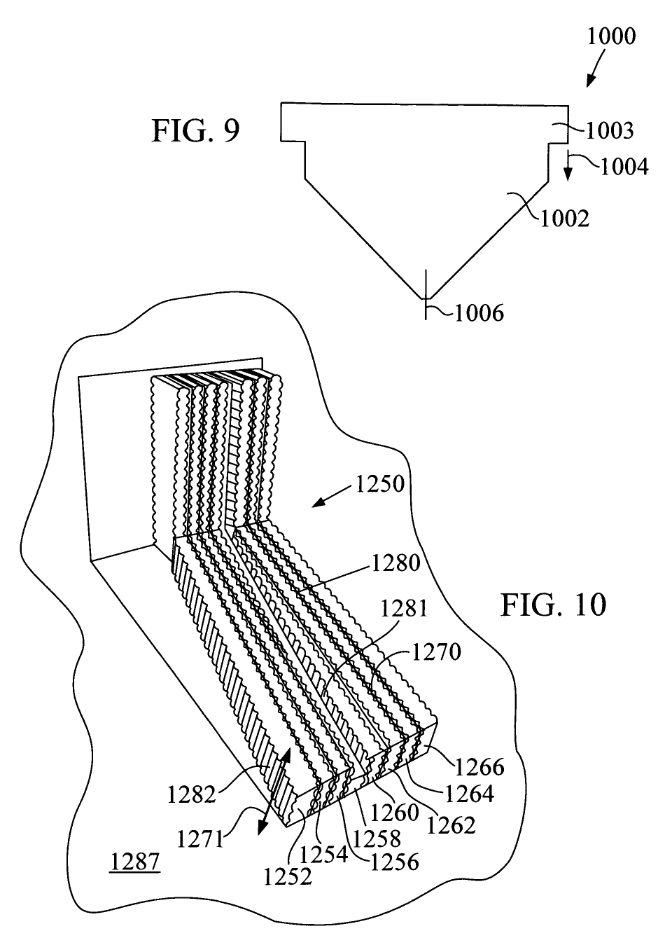

Referring now to FIGS. 9 and 17, there is shown another non-limiting example of a tool 1000 which is made in accordance with the teachings of yet another non-limiting embodiment of the invention. This tool 1000 has a body 1002 which integrally terminates into a ledge or top portion 1003. The body 1002 generally tapers in a direction 1004 from the top portion 1003 toward the generally pointed end portion 1006. The body 1002 may have a frustoconical shape.

In operation, the body 1002 is made to press (in the direction 1003) against the top surface 1012 of a bio-degradable blank 1014 and is effective to partially compress the top surface 1012 to form a pocket within the blank 1014 having a size and a shape with is substantially identical to the size and the shape of the body 1002. Once the pocket is formed, the tool 1000 is retracted away (in the direction 1007) from the blank 1014. The body 1002 may be heated by deploying heating elements, such as heating elements 722,723,724, and 725 within the body 1002 in the previously described manner.

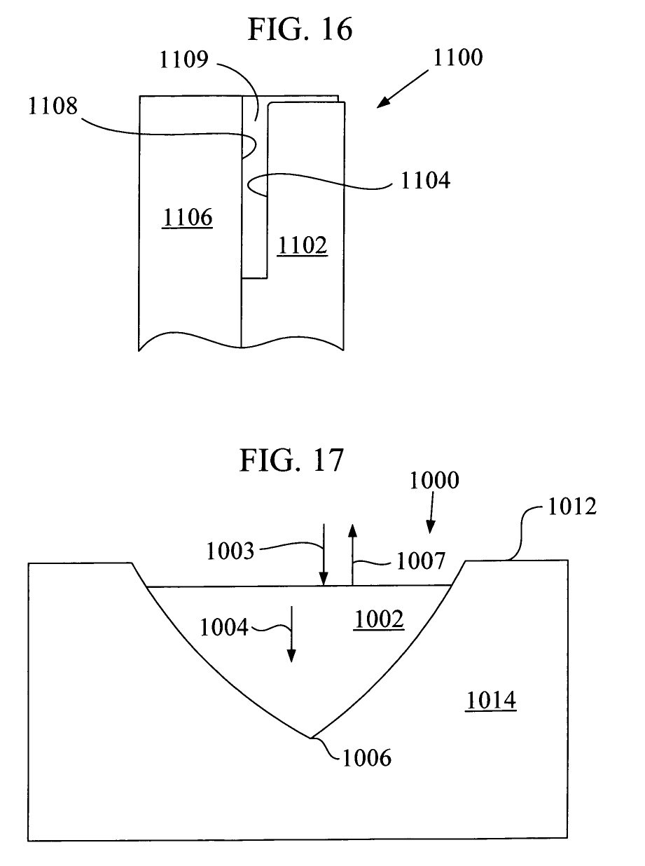

Various types of reception assemblies may be formed by the principles of the various inventions and by the use of the various afore-described tools. For example, as shown in FIG. 16, a reception assembly 1100 may formed from a first bio-degradable portion 1102 having a pocket 1104 which is formed in the previously described manner and a second biodegradable portion 1106 having a flat surface 1108 which overlays the formed pocket 1104 and cooperates with the formed pocket 1104 to create a reception slot or area 1109. The portions 1102 and 1106 may be coupled by the use of glue or some other conventional and known material or fastening strategy.

Other types of non-limiting reception assemblies may similarly be selectively formed. For example, referring now to FIG. 10, there is shown a reception member or assembly 1250 which is made in accordance with the teachings of the various inventions.

As shown, member 1250 includes a plurality of separate and linearly coextensive layers of bio-degradable material 1252, 1254, 1256, 1258, 1260, 1262, 1264, and 1266. It should be appreciated that nothing in this description is meant to limit the number of such layers by a certain amount. Each layer 1252-1266 is separated from a spatially adjacent layer by a reinforcer member 1270 and each reinforcer member 1270 is respectively coupled to respectively adjacent layers 1252-1266 of bio-degradable material and each reinforcer member 1270 is linearly coextensive to each layer of material 1252-1266. Such coupling may be achieved by the use of glue or some other material or by some other fastening technique (such as by use of staples or the like). In this manner, the various layers 1252-1266 are coupled and cooperatively form an assembly. The layers 1252-1266 may or may not be formed from substantially similar bio-degradable material (such as, by way of example and without limitation, that material which is known as “greencell”) and the reinforce members 1270 may or may not be formed from substantially identical material. Non-limiting examples of material which may be used to form the reinforce members 1270 includes cloth, card board, corrugated card board, and/or wood and/or paper.

Upon the surface 1280 may be formed pockets, such as pocket 1281. The pocket 1281 may comprise substantially any desired size and shape, and or any other sort of other spatial formation. In this non-limiting example, the respective longitudinal axis of symmetry 1271 of each of the flutes 1282 are perpendicular to the surface 1287 upon which assembly 1250 resides.

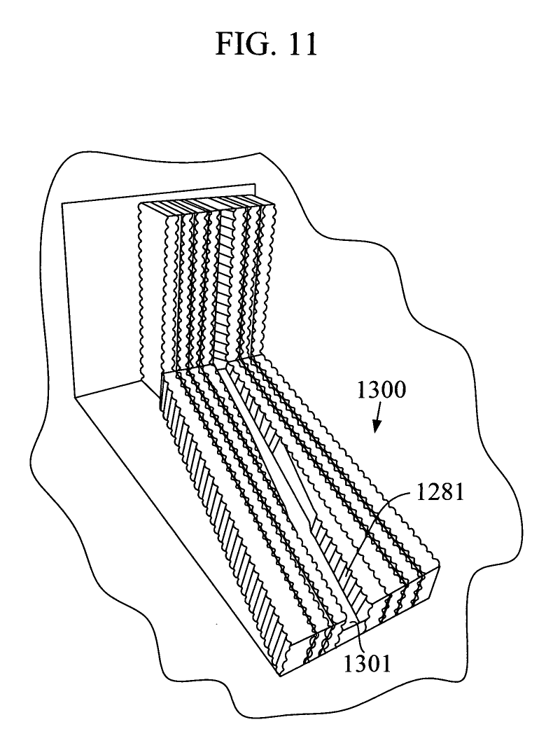

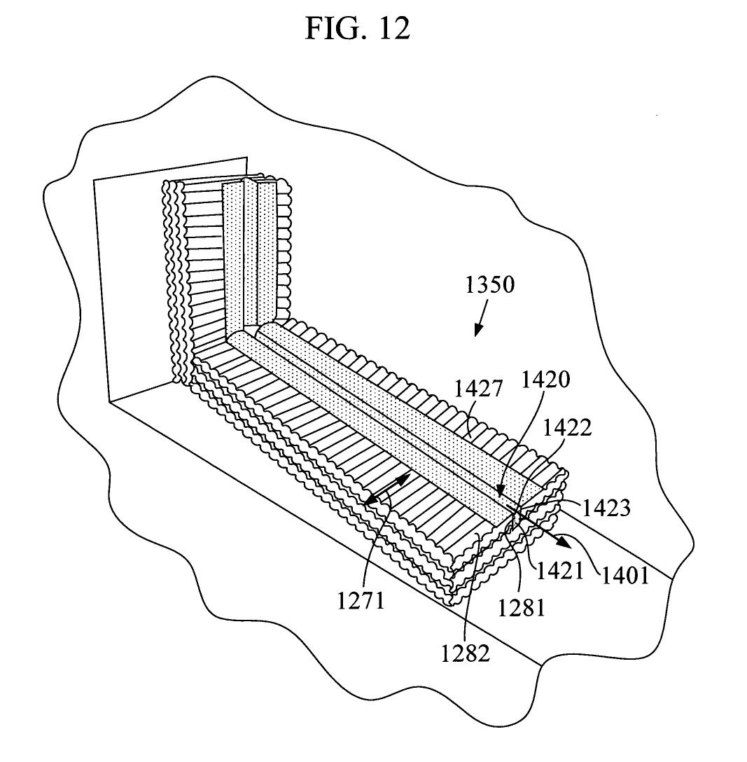

The reception assembly 1300 of FIG. 11 is substantially similar to the reception assembly 1250 which is shown in FIG. 10 except that reinforcer material 1301 is operatively disposed within the pocket 1281. Further, the reception assembly 1350, which is shown in FIG. 12, is substantially similar to the reception assembly 1300 of FIG. 11 except that the flutes 1282 are positioned such that their respective longitudinal axes of symmetry 1271 are each perpendicular to the longitudinal axis of symmetry 1401 of the pocket 1281, there are no reinforcer members 1270 and, within the pocket 1281, there is disposed a “U-shaped” liner 1420 which overlays the bottom pocket surface 1421 and the sides 1422 and 1423, as well as draping over a portion of the top surface 1427.

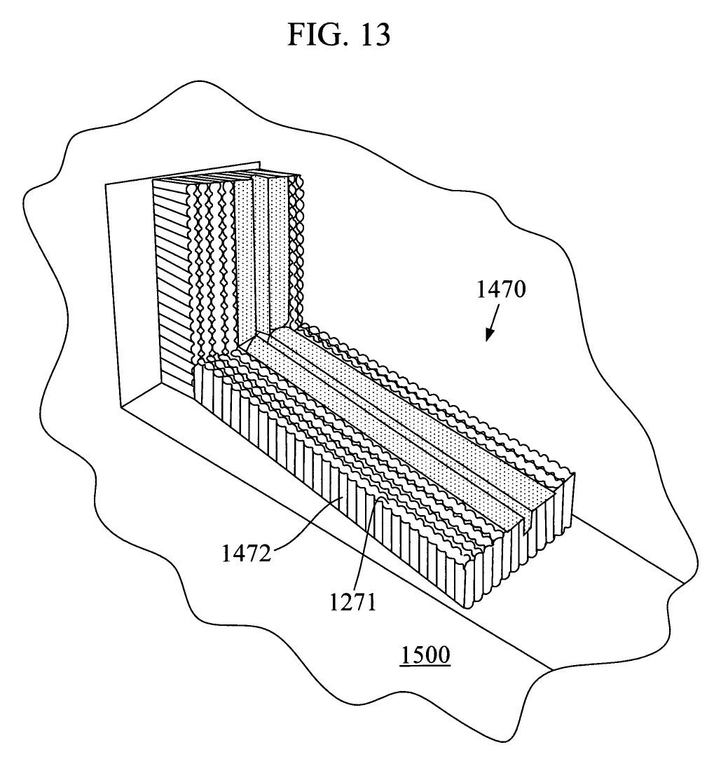

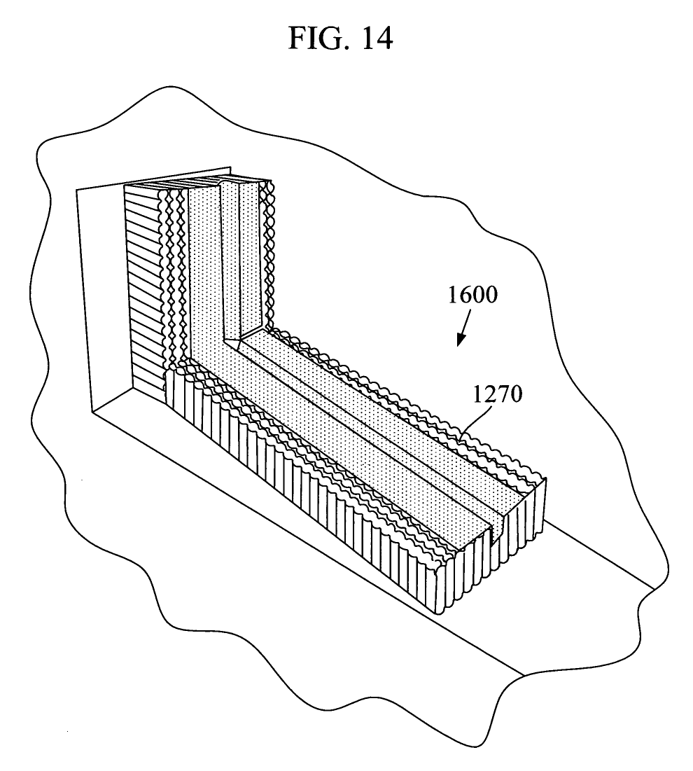

The reception assembly 1470 of FIG. 13 is substantially similar to the reception assembly 1350 except that the flutes 1472 each have a respective longitudinal axis of symmetry 1271 which is normal to the surface 1500 upon which the assembly 1470 resides. The reception assembly 1600 of FIG. 14 is substantially similar to the reception assembly 1470 except that inter-layer reinforcers 1270 are utilized.

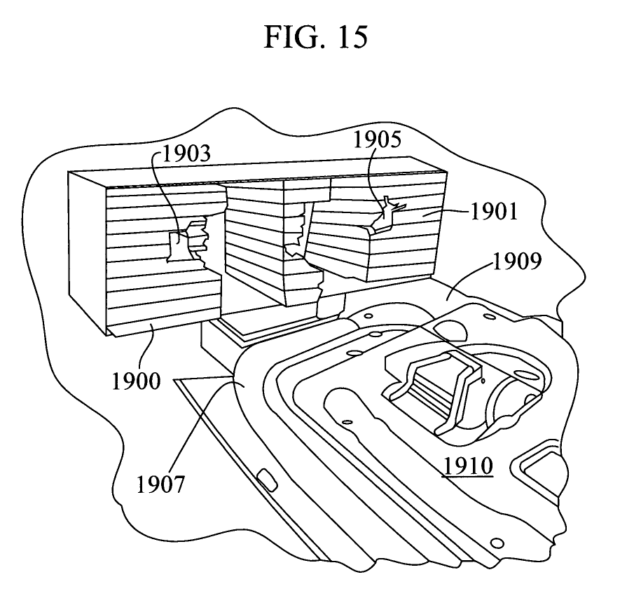

It should be realized that the various reception assemblies may be formed in a desired size and shape. For example, as is shown in FIG. 15, two such reception assemblies 1900, 1901 may be utilized having respective internal reception cavities 1903, 1905 which respectively conform to portions 1907, 1909 of an item 1910 to be received. A third reception assembly 1911 may also be utilized to remain another portion of the item 1910.

Various non-limiting methodologies of the present invention may also be employed in various respective alternate strategies.

For example and without limitation as shown in FIG. 20, a blank 1200 may be created and/or utilized by the present invention. The blank 1200 includes at least two distinct and independent layers 1201, 1202 of a biodegradable material, such as “greencell” which are separated by a reinforcement layer 1203, such as cardboard.

This blank 1200 may be created and/or provided as part of an overall business strategy/methodology. The blank 1200 maybe cut after it is provided/formed, or the layers 1201, and/or 1202 may be individually cut and formed as desired, before they are coupled by use of the reinforcement layer 1203. The cutting can be where it is desired and when it is desired. The layer 1203 may be attached (such as by the use of glue) to layers 1201, 1202, only where it is desired to be attached. That is, layer 1203 may not overlay all of the respective layers 1201, 1202. Additional layers of biodegradable material layer separated by an adjacent layer but a reinforcement material 1203 may be utilized. Further, each layer 1201, 1202, 1203 may have different geometric properties (e.g., width, length, height) and may be respectively and selectively coated with such material as corn starch to enhance the rigidity of the blank and enhance the adhesion of the various layers 1201, 1202, 1203.

Applicant has found it to be desirable to structurally strengthen reception assemblies which are provided with biodegradable material because such assemblies may not provide the damage protection (e.g., such as impact related damage) to the contained item which is presently provided by non-biodegradable alternatives. In this regard, several strategies have been developed which allow various dissimilar biodegradable reception assemblies to be created.

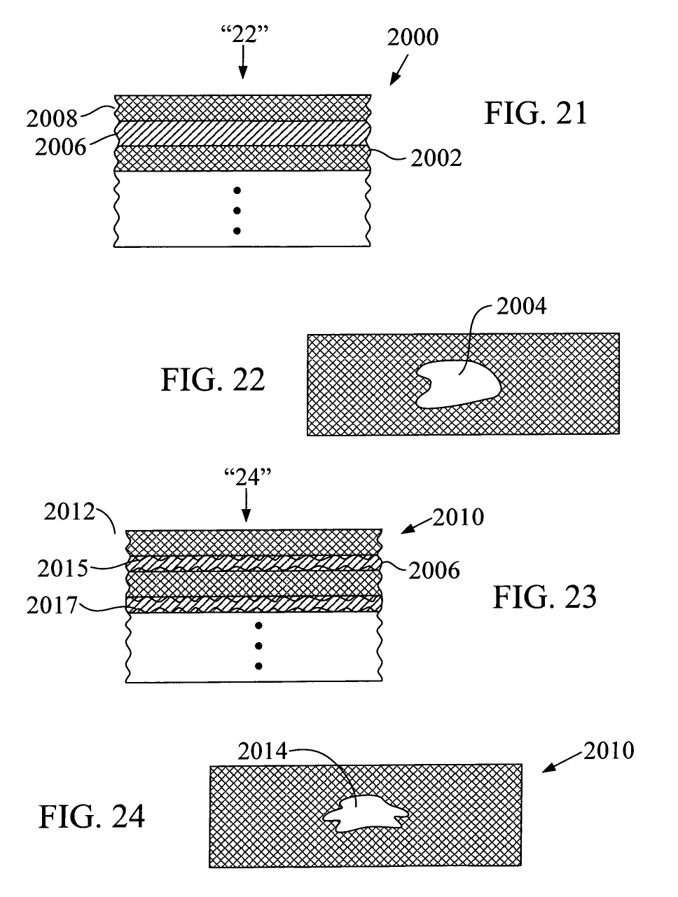

By way of example and without limitation, reference is now made to FIGS. 21 and 22 where there is shown a structurally enhanced biodegradable reception assembly 2000 which is made in accordance with the teachings of an alternate embodiment of the inventions. That is, assembly 2000 comprises a body 2002 which may of any desired shape and sized but, for illustration purposes only, is shown to be generally cubical. Within the body 2002 is formed a reception portion or cavity 2004 which is adapted to selectively, removably, and securely receive one or more items. It should be appreciated that the reception portion or cavity may have substantially any desired geometric configuration. Thus, it should be appreciated that with regards to this assembly 2000 and all other assemblies which will be discussed, that nothing in this description is meant to limit the shape or size of these assemblies to a particular configuration and that the various geometric configurations which are shown and discussed are for illustrative purposes only and are non-limiting in nature.

In this assembly configuration 2000, the body 2002 is formed of alternating layers of reinforcement material 2006 and biodegradable foam 2008. In one non-limiting embodiment, the biodegradable foam 2008 comprises that which is known as Greencell and the reinforcement material 2006 comprises that which is commonly referred to as cardboard, although certainly other materials may be utilized. In this non-limiting configuration 2000, each layer 2008, 2006 is flat.

Referring now to FIGS. 23 and 24, there is shown a reception assembly 2010 which is made in accordance with yet another alternative strategy of this invention and which includes a body 2012 and a reception cavity 2014. The assembly 2010 differs from the assembly 2000 in that each of the layers of reinforcement material 2006 are convoluted in shape (e.g., each layer 2006 has opposed and undulating shaped surfaces 2015, 2017).

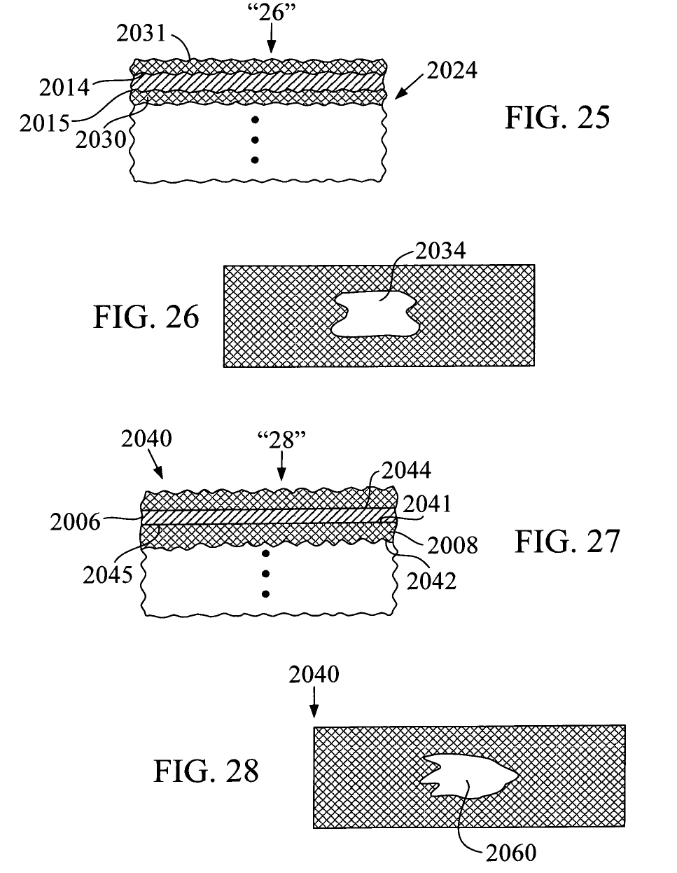

Referring now to FIGS. 25 and 26, there is shown a reception assembly 2024 which is made in accordance with the teachings of yet another alternative embodiment of the invention. Assembly 2024 differs from assembly 2000 in that each of the foam layers 2008 and each of the reinforcement layers 2006 have opposed and interfacing undulating surfaces (e.g., undulating surfaces 2030, 2031 of foam layer 2008 and undulating surfaces 2014, 1015 of reinforcement layer 2006).The assembly 2024 includes a reception cavity or slot 2034 which may be substantially similar to cavity or slot or opening 2004.

Referring now to FIGS. 27 and 28, there is shown an assembly 2040 which is made in accordance with the teachings of another alternative embodiment of the invention. Assembly 2040 differs from assembly 2000 in that each layer of foam 2008 has opposed undulating surfaces 2041, 2042 while each reinforcement layer 2006 has substantially smooth interfacing surfaces 2044, 2045. The assembly 2040 includes a cavity or opening or slot 2060 which may be substantially similar to cavity or opening or slot 2004.

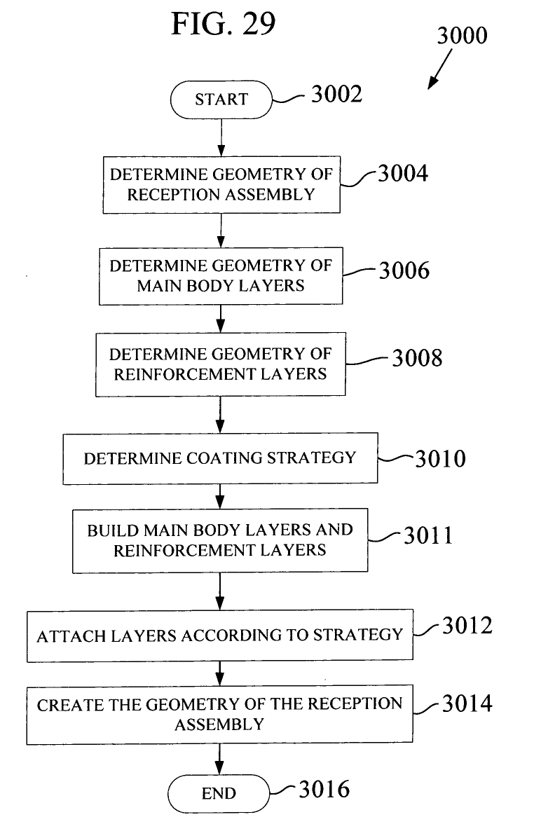

Referring now to FIG. 29, there is shown a methodology 3000 which includes a plurality of steps which cooperatively define the assembly creation methodology of the present inventions. Particularly, the methodology 3000 includes an initial step 3002 in which a user determines that an assembly, such as by way of example and without limitation, an assembly 2000 is desired to be created. Step 3002 is followed by step 3004 in which the size and shape of the assembly to be created is determined. Step 3004 is followed by step 3006 in which the size and shape of the foam layers is determined and step 3006 is followed by step 3008 in which the size and shape of the reinforcement layers is determined. It should be realized that the layer structure of an assembly, such as assembly 2000, need not have alternating layers of reinforcement and foam material. For example, reinforcement material need not be placed between each two adjacent foam layers. Step 3010 follows step 3008 and, in this step 3010, it must be determined whether a coating is to be applied to any of the layers. Step 3010 is followed by step 3011 in which the layers are built or created and then step 3011 is followed by step 3012 in which the layers are attached according to the predetermined structural needs. Alternatively, the layers are attached as soon as they are created. Step 3014 follows step 3012 and, in this step 3014, the reception assembly is formed. Step 3016 follows step 3014 and, in this step 3016, the methodology is ended.

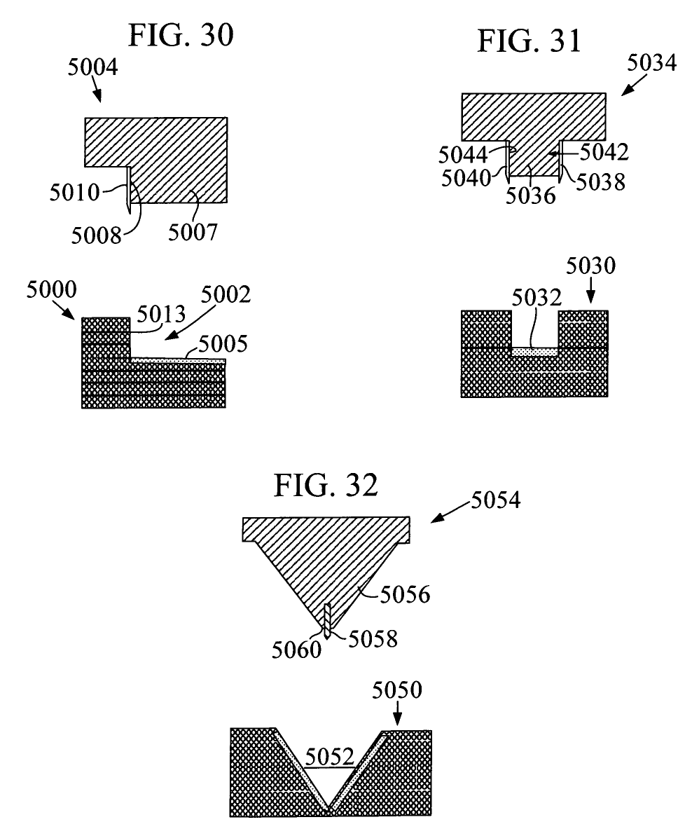

It should be appreciated that various shaped tools may be used to create the desired reception assembly. Typically, the assembly is built in the form of a cube, although other geometries may be utilized. For example and without limitation, as shown best in FIG. 30, if an assembly 5000 having an “L-shaped” reception assembly 5002 (having a valley 5005) is desired than a tool 5004 having a generally rectangular protuberance 5007 is built and along one edge 5008 of the protuberance 5007 there is deployed a blade 5010. The blade 5010 cuts the assembly 5000 along edge 5007 and the protuberance 5013 is forced against the various layers and is effective to compress the various reinforcement and foam layers, thereby forming the valley 5005.

If an assembly 5030 having a substantially “U-shaped” valley 5032 is desired (see FIG. 31), than a tool 5034 is created and includes a “U-shaped” protuberance 5036 having blades 5038, 5040 respectively deployed on sides 5042, 5044. As the protuberance 5036 is forced against the assembly 5030, the blades 5038, 5040 cut the assembly 5030 and the protuberance 5036 compresses the various layers, thereby forming the compressed valley 5032.

If an assembly 5050 is desired having a substantially “V-shaped” valley 5052 (see FIG. 32), then a tool 5054 is created and has a “v-shaped” protuberance 5056 with a cutting blade 5058 positioned within and projecting from the apex 5060 of the protuberance 5056. The projecting blade 5058 cuts the assembly 5050 as the protuberance 5056 compresses the various layers into the shape of the valley 5052.

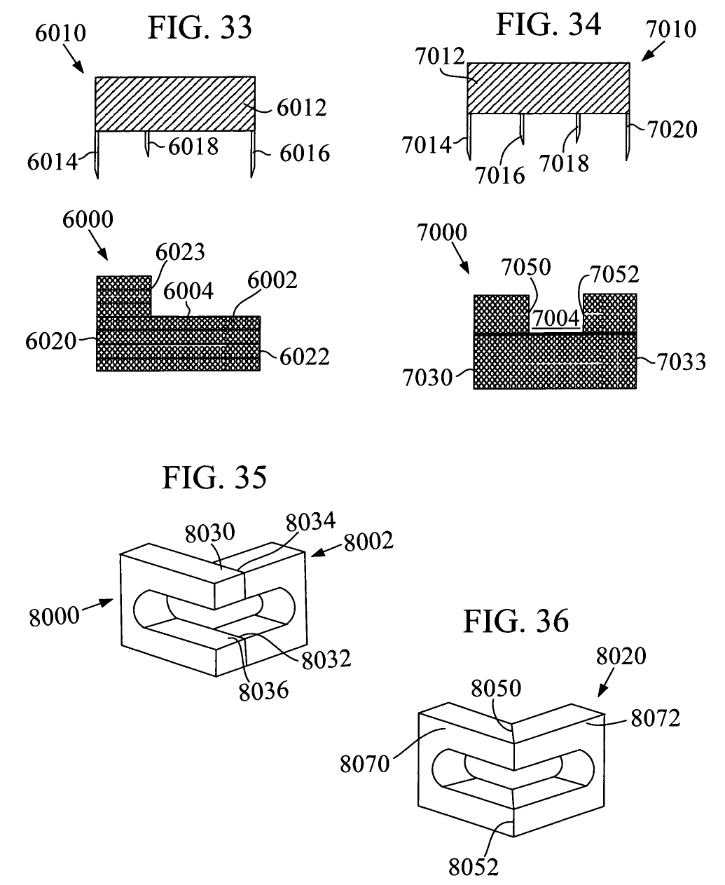

Referring now to FIG. 33, an assembly 6000 may be created and which includes a generally “L-shaped” body 6002 having a generally flat valley or depressed portion 6004. The assembly 6000 has an overall shape which is substantially identical to the overall shape and geometric orientation of the assembly 5000. However, the assembly 6000 may be created by a tool 6010 having a body 6012 with a generally rectangular cross sectional area and protruding blades 6014, 6016, and 6018. Blades 6014 and 6016 are substantially identical and are used to respectively cut the assembly 6000 from a larger assembly. That is, blades 6014, 6016 respectively form the edges 6020 and 6022. The blade 6018 cuts the assembly blocks along edge 6023 and allows the portion of the block residing within the valley 6004 to be easily removed.

Referring now to FIG. 34, an assembly 7000 may be created and which is substantially similar to assembly 5032 and which has a substantially “U-shaped” cavity or reception area 7004. This area 7004 may be created by tool 7010 which has a body 7012 having a generally rectangular cross sectional area and four blades 7014, 7016, 7018, and 7020 and blades 7014 and 7020 respectively cut the edges 7030and 7033 from the best of the block from which the assembly 7000 is taken. The blades 7016 and 7018 respectively form the edges 7050, 7052 of the cavity 7004, thereby allowing the material which resided within the cavity 7004 to be easily removed. Further, assembly 7000 may be created by modifying the tool 7010 to remove the blades 7016, 7018. In this configuration, the tool 7010 created the edges 7030 and 7033 and reception area 7004 is created by a separate tool or process. Similarly, the blade 6018 if the tool 6010 may be removed and the edges 6020 and 6022 are formed by the modified tool 6010 and the valley 6004 is created by a separate tool and/or process.

Referring now to FIG. 35, two C-shaped members 8000, 8002 may be joined (surfaces 8030, 8032 of member 8000 are respectively glued or otherwise joined to respective surfaces 8034, 8036 of member 8002) to cooperatively form a butt joint arrangement.

Referring now to FIG. 36, instead of joining two separate members, a single member 8020 may be bent into a corner forming a “living hinge” at portions 8050, 8052. Alternatively, member 8020 may be initially formed from two separate members 8070, 8072 which are glued before the member 8020 is bent and such bending occurs without breaking the bond between the previously joined members 8070, 8072.

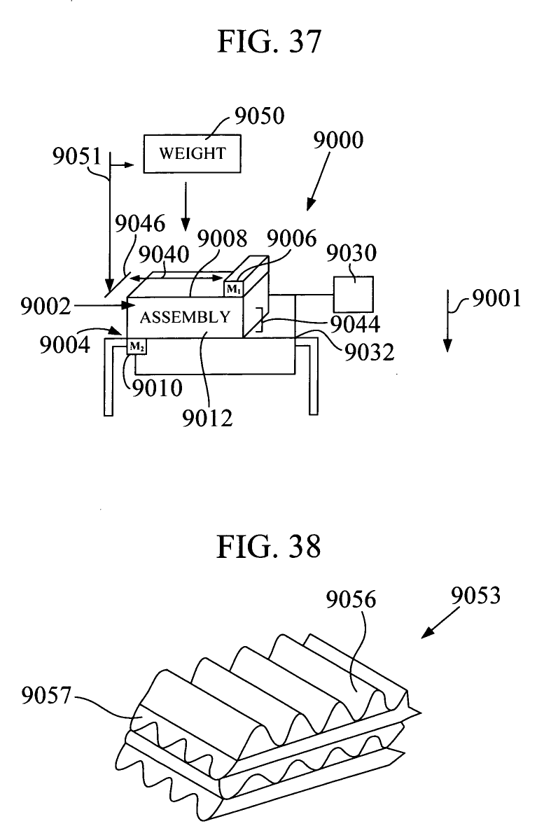

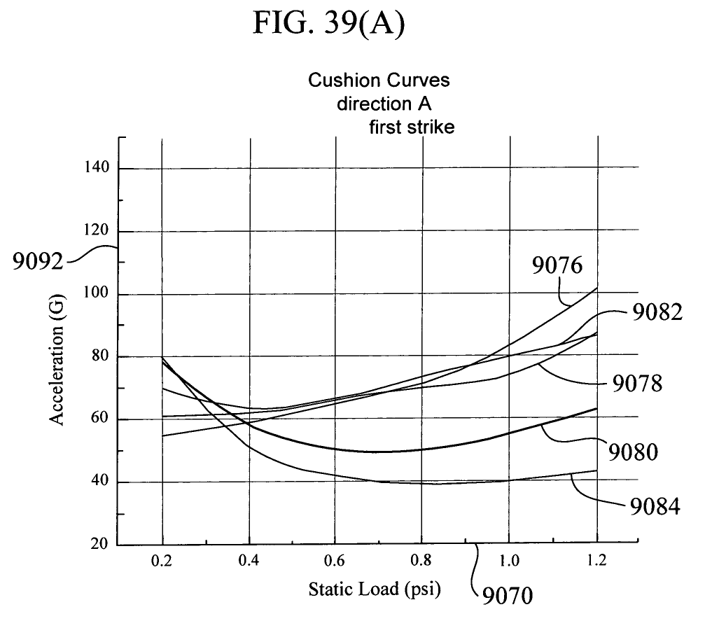

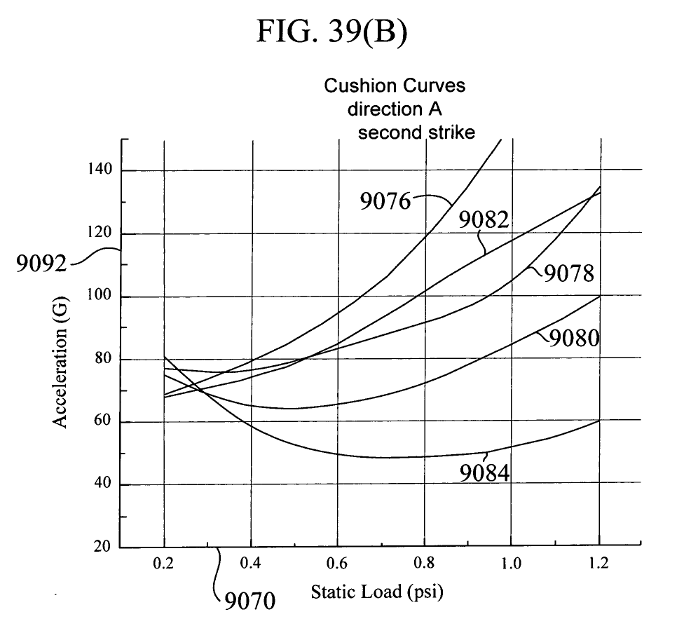

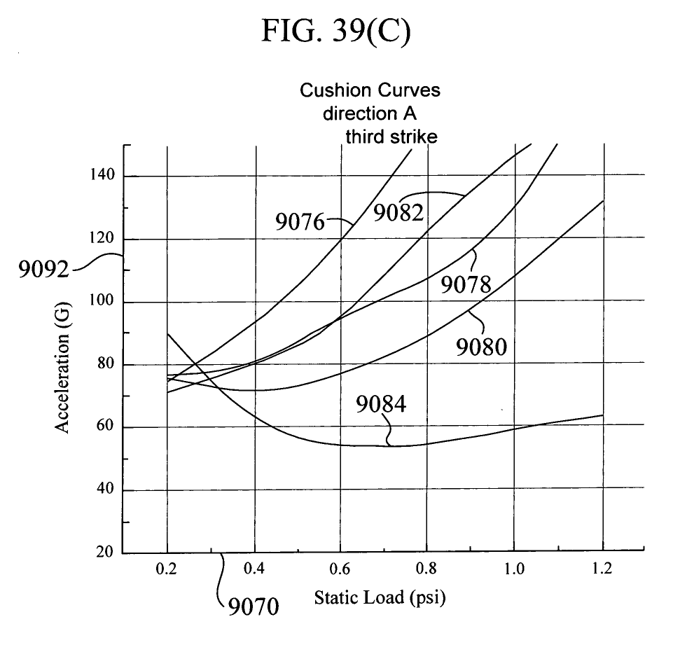

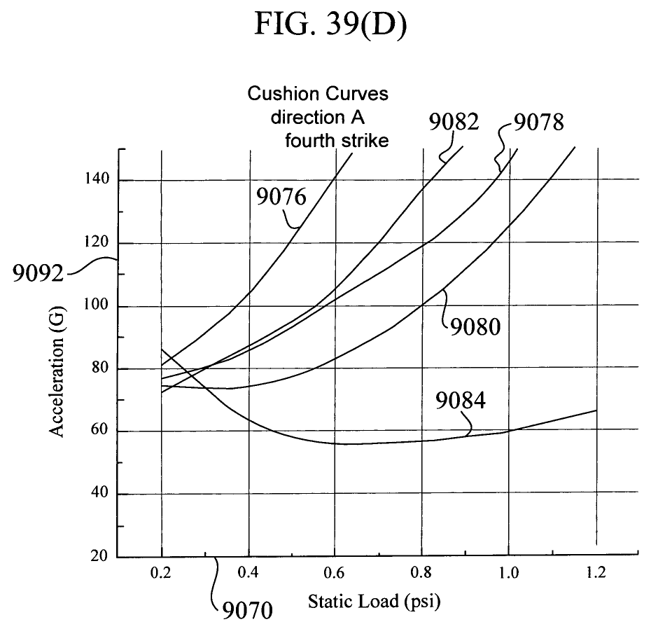

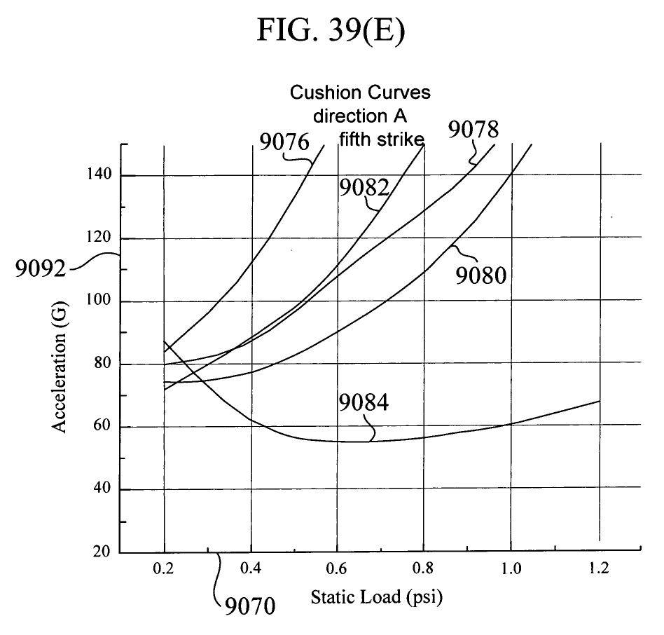

Referring now to FIG. 37, there is shown a block diagram 9000 which pictorially and diagrammatically represents certain testing which was accomplished on some reception assemblies which are made in accordance with the teaching of the various embodiments of the inventions.

Particularly, a reception assembly to be tested, such as assembly 9002, is placed upon a table or other flat surface 9004 and a load cell (a sensor) 9006 is coupled to a first or upper surface 9008 of the assembly 9002 and/or is coupled to a second surface 9012 of the assembly 9002. In a separate embodiment, only one accelerator may be used in place of load cells 9006. Alternatively, a load cell may be coupled to surface 9008 and an accelerometer which may be coupled to surface 9012. The load cells 9006 were each physically and communicatively coupled to a computer processor assembly 9030 by the use of bus 9032 and the sensors 9010, 9006 respective measure any load applied to surface 9008 and any subsequent acceleration of the assembly 9002 in the direction of arrow 9001, as a result of any applied load. Particularly, each of the various assemblies which will be discussed and which were subjected to this test procedure were had a width 9040 of about six inches, a height 9044 of about two inches, and a length 9046 of about six inches. Various weight 9050 were dropped at a single height 9051 above the assembly under test 9002 to effectuate various striking forces upon the assembly 9002, which will be discussed later with regards to the graphical drawings, namely FIGS. 38(A-E). The height 9051 was about thirty inches. The testing conformed to and comprised the well known ASTM D 1596-97 “Test Method For Dynamic Shock Cushioning Characteristic Of Packaging Material” which was created by the ASTM (American Society of Testing Material) Organization. The weights 9050 each comprises a six inch square plate and respectively comprises weights of about 7.2 pounds which yielded a static pressure of about 0.2 pounds per square inch and a weight of about 14.4 pounds which yielded a static pressure of about 0.4 pounds per square inch. The first assembly to be tested comprised only commercially available Greencell material and the second assembly to be tested comprised an assembly having alternating layers of Greencell and flat paper, each greencell layer having opposed undulating surfaces and it was these respective opposed undulating surfaces which contacted dissimilar materials. One example of this second assembly is shown in FIG. 27. The third assembly comprises only Greencell after the entire assembly (all of the Greencell) has been compressed, and the fourth assembly to be tested was substantially similar to the second assembly to be tested except that the intermediate Greencell layers were rotated about ninety degrees. That is, as shown in FIG. 38, this fourth assembly 9053 had respective flutes 9056 of each stacked layer 9057 being orthogonally laid upon to the flutes of each adjacent layer. The fifth assembly comprises only 2.2 pounds per cubic foot. Polyethylene (PE) which is currently used in various shipping applications and which represented a performance benchmark.

Referring now to FIG. 38(A-E), there are shown graphical results for the foregoing testing operation. Particularly, on the first axis 9070 are data related to or representative of the measured load upon the tested assembly and on the second axis 9092 are data related to or representative of the amount of structural deformation or acceleration of the assembly under test when the various loads were applied. The respective curves 9076, 9078, 9080, 9082, and 9084 respectively represent data for test assembly one, assembly, two, assembly three, assembly four, and assembly five. The respective FIGS. 38(A-E) represents successive strikes of the assemblies.

As shown, the compressed Greencell outperformed all other assemblies (low amount of structural degradation at high loads), except the fifth assembly. All of the five assemblies degraded over various successive strikes. However, the compressed

Greencell assembly degraded the least amount of all of the biodegradable based assemblies. However, given the cost benefit of the assemblies and their relatively good performance, each of the assemblies one through four do provide adequate protection for many shipping applications. Thus, the biodegradable material may be initially compressed and then made to form a reception assembly or compressed as part of the reception assembly forming process.

It is to be understood that the inventions are not limited to the exact construction or methodology which has been delineated above, but that various changes and modifications may be made without departing from the spirit and the scope of the inventions as are more fully delineated in the following claims. Thus, from the foregoing, it should be appreciated that process/methodology 10 provides the creation of reception members/assemblies which are bio-degradable and by use of process which is both cost effective and which does not use harmful chemicals/substances.

What is claimed is:

1) A method for forming a reception assembly compromising the steps of obtaining biodegradable material; cutting said biodegradable material; and only after cutting said biodegradable material, forming a pocket within said cut biodegradable material.

2) A method for forming a reception assembly is provided and includes the steps of obtaining biodegradable material; cutting said biodegradable material to form at least a perimeter of a pocket; and compressing the portion of said biodegradable material which resides within said perimeter, thereby forming a pocket.

3) A method for forming a reception assembly compromising the steps of obtaining a first biodegradable portion; obtaining a second biodegradable portion having a flat surface; cutting said first biodegradable portion; forming a pocket within said first biodegradable portion only after said first biodegradable portion is cut; coupling said second biodegradable portion to said first biodegradable portion such that said flat surface of said second biodegradable portion overlays said formed pocket, thereby, forming a reception assembly.

4) A method of forming a reception assembly compromising the steps of forming a first layer of biodegradable material; forming a second layer of biodegradable material; obtaining a reinforcer; placing said reinforcer between first and second layers of biodegradable material; and coupling said reinforcers to said first and second layers of the biodegradable material, thereby, forming a reception assembly.

5) A method for forming a reception assembly compromising the steps of obtaining a first portion of biodegradable material; obtaining a second portion of biodegradable material; determining the shape of an item to be received by the reception assembly; shaping the first portion of the biodegradable material to the shape of a first portion of the determined shape; shaping the second portion of the biodegradable material to the shape of a second portion of the determined shape; and causing said shaped first biodegradable portion to be positioned with respect to the second biodegradable portion, effective to cause the first and second biodegradable portions to cooperatively form a reception assembly.

6) A method for forming a reception assembly comprising the steps of obtaining biodegradable material; compressing said obtained biodegradable material; and forming said reception assembly from said compressed biodegradable material.

7) A reception assembly compromising a plurality of separate layers of biodegradable material which are each separated and coupled to a reinforcer.
